(19) United States
(12) Patent Application Publication
(10) Pub. No.: US 2007/0180435 A1
(43) Pub. Date: Aug. 2, 2007

(54) Method for implementing applications in processor-controlled facilities

(75) Inventors: Thomas Hunteler, Munchen (DE); Klaus Wenninger, Wiener Neustadt (AT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/657,913

(22) Filed: Jan. 25, 2007

(30) Foreign Application Priority Data
Jan. 27, 2006 (EP) 06001746.4

(51) Int. Cl. G06F 9/45

(52) U.S. Cl. 717/136

(57) ABSTRACT

A processor platform (HW) of a processor-controlled facility (PC) is configured such that independent partitions (P1, P2) can be set up, with an operating system (OS1, OS2) being assigned to a partition (P1, P2) and at least one application (APP(OF,TEL)) being assigned to said operating system (OS1, OS2). The functional scope of the respective operating system (OS1, OS2) is optimized for the respective at least one application (APP(OF,TEL)). By using a common processor platform (HW) and optimizing the operating systems (OS1, OS2) to the requirements of the respective application (APP(OF,TEL)), it is possible to achieve a particularly economical realization, with only those applications necessary for the operation of the respective application (APP(OF,TEL)) being realized in the operating system (OS1, OS2). The independent nature of the partitions (P1, P2) means that the applications (APP(OF,TEL)) are highly available compared with the known software solution for applications.

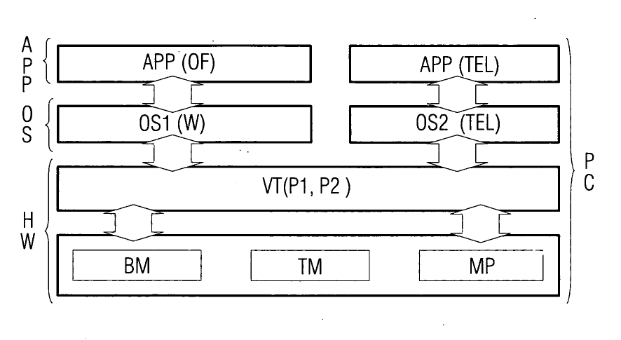

### CROSS REFERENCE TO RELATED APPLICATIONS

This application claims priority of European application No. 06001746.4 EP filed Jan. 27, 2006, which is incorporated by reference herein in its entirety.

### FIELD OF INVENTION

The present invention relates to implementing applications in processor-controlled facilities.

### BACKGROUND OF INVENTION

Facilities such as telephones, communication systems or home entertainment or computer-related facilities, such as TVs, videos or printers, etc., are predominantly realized by processor-controlled facilities, which provide a high-availability and highly reliable service. The service is hereby controlled by software in each instance, said software being integrated into the respective facility as an application. Each of the facilities therefore has to be equipped with the corresponding complex environment, such as power supply and cabling. When one application or a number of applications is/are integrated into a facility, realized for example by a personal computer, the fact that the personal computer is not constantly ready for operation means that the respective applications are not available all the time and the mutual influences of the applications affect the reliability of the respective applications.

### SUMMARY OF INVENTION

An object of the invention is to improve the realization of home entertainment, communication and computer-related facilities controlled by applications. The object is achieved by the features of the independent claims.

The significant aspect of the invention is that a processor platform of a processor-controlled facility is configured such that independent partitions can be set up and an operating system and at least one application is assigned to a partition, with the functional scope of the operating system being optimized to the at least one application. The applications are advantageously realized by home entertainment or telecommunication-specific applications.

One significant advantage of the invention is that the applications can be operated and maintained totally independently of each other with the aid of separate operating systems on a single processor platform and can be activated or deactivated independently of each other. This means that the applications can be operated in a robust and stable manner, like applications implemented in separate processor-controlled facilities. By using a common hardware platform and optimizing the operating systems to the requirement of the respective application, it is possible to achieve a particularly economical realization, with only those applications necessary for the operation of the respective application being realized in the operating system. The independent nature of the partitions means that the applications are highly available compared with the known software solution for applications.

Advantageous developments of the inventive method and inventive embodiments of a processor-controlled facility will emerge from the dependent claims.

### BRIEF DESCRIPTION OF THE DRAWING

The invention is described in more detail below with reference to a diagram. The sole FIGURE shows a block circuit diagram of the structure of an inventively configured processor-controlled facility or a personal computer PC.

### DETAILED DESCRIPTION OF INVENTION

The FIGURE shows a block circuit diagram of the structure of an inventively configured processor-controlled facility or a personal computer PC. Generally a personal computer PC is divided into two essential areas—the hardware-type or physical components—referred to in the FIGURE as HW and below as hardware HW and the software or programs. The link between the hardware HW and the software is represented by an operating system OS. In the case of a personal computer PC the hardware HW generally contains a microprocessor system MPS with at least one microprocessor including the peripheral components, such as main memory, input/output module, etc.—not shown in detail in the FIGURE. A microprocessor system MPS with two microprocessors, i.e. one redundant microprocessor system MPS, is advantageous for a personal computer PC, which is provided for a number of applications APP.

A further element of the hardware HW is a boot module BM, with the aid of which an operating system OS can be loaded. The hardware HW or physical components of the personal computer PC also include what are known as “Trusted Modules” TM, which essentially represent the peripheral hardware such as the memory, disk drives or interface modules.

According to the invention the hardware HW also includes a virtualization technology realized by a virtualization module VT, which can be used to set up largely independent, virtual partitions P1, P2 in the hardware HW. With the aid of the virtualization technology the hardware HW is emulated for each of the following operating systems and applications such that the operating systems OS do not perceive that the hardware HW or physical resources are distributed among the operating systems OS. This means that the respective required hardware resources are allocated temporarily to the operating systems OS, with the respective requirements of the respective operating systems OS being implemented in an isolated manner, thereby achieving a high level of reliability and availability. The virtualization technology is realized by means of programs in a hardware-type manner and is provided by different manufacturers such as Intel, AMD, etc.

A number of operating systems can be loaded into a virtualization module VT. For the exemplary embodiment it is assumed that two operating systems OS1, OS2 are loaded into the virtualization module VT, with the first operating system OS1 being designed for a Windows application APP(OF) and the second operating system OS2 being designed for a telephone application APP(TEL). The Windows application APP(OF) is for example an Office application OF, which for example contains the following sub-applications according to table 1:

TABLE 1

```
Applications:
  Browser e.g. Explorer
  Office application
    Excel
    Word
    PowerPoint
    Access
    Acrobat Reader
    Netmeeting
    Outlook
  Media (DVD/TV) player SW
  Development environments
  Paint SW
  Picture SW (e.g. PhotoShop)
  Workgroup SW (SAP, Lotus Notes, . . . )
  IP phone SW.
```

The telephone application APP(TEL) is provided in the personal computer PC, for example for setting up and canceling telephone connections by way of the internet and controlling features and making calls. To this end a headset or a microphone and speaker—not shown—is/are provided, with these facilities being integrated into the hardware HW of the personal computer PC. Input modules have to be provided for user input for the telephone application APP(TEL).

According to the invention the respective operating system OS1, OS2 is optimized in respect of the application APP used. For the Windows application APP(WIN) it is assumed in the case of the exemplary embodiment that a known operating system OS Windows W is assigned to the first partition P1. The operating system OS Windows W is optimized for the Windows application APP(OF) Office O and has the following features according to table 2:

TABLE 2

| | |
|---|---|
| HW driver: | SW middleware: |
| network | TCP/IP stack |
| display (graphic cards) | netbios |
| USB | IPX |
| printer | video codec |
| keyboard | audio codecs |
| audio | G.711 |
| TV tuner | G.729 |
| V.24 driver | G.726 |
| DVD/CD device | AC3 |
| flash card driver | MP3 |
| game controller | file & printer sharing SW |
| | dial up SW |
| | fonts |
| | file systems |
| | NTFS |
| | CDFS ISO9660 |
| | Samba |
| | EXT3 |
| | VFS |
| | FAT32(16) |
| | encryption SW |
| | compression SW |
| | virus scanner |
| | backup SW |
| | . . . |

According to the invention the second operating system OS2 is optimized to the telephone application APP(TEL), with provision being made in the case of the exemplary embodiment for using the telephone application APP(TEL) of the application Office O—shown in the first table 1 as IP phone SW. It is also assumed that the operating system Windows W has to be optimized for this application IP phone SW. As far as the telephone application APP(TEL) is concerned, this means that only the IP phone SW is assigned to the second partition P2.

After the operating system Windows W has been optimized for the telephone application APP(TEL) IP phone SW, according to table 3 the second, optimized operating system OS2 has the following functions:

TABLE 3

| | |
|---|---|
| HW driver: | SW middleware: |
| USB | TCP/IP stack |
| keyboard | audio codecs |
| audio | G.711 |
| | G.729 |
| | G.726 |
| | file systems |
| | NTFS |

As shown in table 3, the second operating system OS2 only has the functions required to control the telephone application APP(TEL). These are specifically the hardware drivers USB, keyboard, audio for the physical connection to the microphone, the speaker and the input keyboard and the middleware realized in the hardware HW TCP/IP stack, audio codecs G.711, G.729, G.726 and file system NTFS to control the requirements imposed by the telephone application APP(TEL), the different compression standards for voice transmission by way of the IP network and the imaging of files.

By assigning the two operating systems OS1, OS2 to different partitions P1, P2,

1.-11. (canceled)

12. A method for application implementation in a processor-controlled facility, comprising:
setting up a first independent partition and a second independent partition on a processor platform;
assigning a first operating system to the first partition and to a first application;
assigning a second operating system to the second partition and to at least a second application, and
optimizing a functional scope of each operating system based on the application assigned to the respective operating system.

13. The method as claimed in claim 12, wherein the first or the second application is a home entertainment application or a telecommunication-specific application.

14. The method as claimed in claim 13, wherein in that the processor platform has virtualization technology for processors to set up the partitions.

15. The method as claimed in claim 14, wherein each operating system is optimized such that only a function required for the respective application is realized for a requirement in respect to the physical components of the processor platform.

16. The method as claimed in claim 15, wherein at least one of the operating systems is optimized such that the operating system is designed in an optimum manner for the requirement of the respective application.

17. The method as claimed in claim 15, wherein at least one of the operating systems is optimized such that an operating system function is reduced to satisfy the requirement of the respective application.

18. The method as claimed in claim 15, wherein at least one of the operating systems is optimized such that an operating system function is enhanced to satisfy the requirement of the respective application.

19. The method as claimed in claim 12,
wherein an additional component is provided for at least one of the applications and
wherein an additional function is provided for the additional component in the operating system.

20. The method as claimed in claim 12, wherein the first application communicates with the second application via an interface of the processor platform.

21. A processor-controlled facility for implementing applications, comprising:
a processor platform for setting up a first independent partition and a second independent partition;
an operating system for the first partition;
an application assigned to the operating system;
wherein the operating system is configured such that a functional scope of the operating system is optimized for the application.

22. The facility as claimed in claim 19, wherein the application is realized as a computer program.

23. The facility as claimed in claim 19, wherein the application is a home entertainment application or telecommunication-specific applications.

24. The facility as claimed in claim 19, wherein the operating system is optimized such that only a function required for the application is realized for a requirement of the respective application in respect of the physical components of the processor platform.

25. The facility as claimed in claim 19, wherein a virtualization technology is provided for setting up first and second partitions and is realized by a virtualization module.
